(19) United States
(12) Patent Application Publication
(10) Pub. No.: US 2008/0195449 A1
(43) Pub. Date: Aug. 14, 2008

(54) Techniques to manage cost resources

(75) Inventors: Darius Snapkauskas, Sammamish, WA (US); Raju Iyer, Newcastle, WA (US); Bram De Vries, Amsterdam (NL); David Ducolon, Auburn, WA (US); William John Olford, Media, PA (US)

Correspondence Address: MICROSOFT CORPORATION, ONE MICROSOFT WAY, REDMOND, WA, 98052-6399, US

(73) Assignee: Microsoft Corporation, Redmond, WA (US)

(21) Appl. No.: 11/704,099

(22) Filed: Feb. 8, 2007

(51) Int. Cl. G06Q 10/00

(52) U.S. Cl. 705/8

(57) ABSTRACT

Techniques to manage cost resources are described. An apparatus comprises a project management program arranged to schedule resources for a project. The project management program includes multiple resource types with one of the resource types comprising a cost resource type. The cost resource type may have multiple defined cost resources each representing a cost value independent of a volume of work for a task or a duration for the task. Other embodiments are described and claimed.

### BACKGROUND

Project management software is a term covering many types of application software that are used to deal with the complexity of large projects. Project accounting is the practice of creating financial reports specifically designed to track the financial progress of projects, which can then be used by managers to aid project management. Typically project management software and project accounting software are implemented as separate packages. Further, project management software typically does not incorporate many project accounting techniques and resources to facilitate interoperability with project accounting or other financial software. Consequently, project management software may have difficulty in tracking the many different types of costs associated with a project. Accordingly, there may be substantial need for improvements in project management software to assist in the financial management of a project.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Various embodiments are generally directed to techniques to manage cost resources for a project. In one embodiment, for example, a project management program may be arranged to schedule resources for a project. The project management program may include multiple resource types that may be assigned to a project. One of the resource types may comprise a novel resource type related to financial management. In one embodiment, for example, the novel resource type may be referred to as a cost resource type. The cost resource type may be used to define multiple cost resources for a project. Each cost resource typically represents a cost value independent of a volume of work for a task or duration for a task.

In one embodiment, for example, a cost resource may be assigned to a defined task. In some cases, multiple cost resources may be assigned to the same task. In addition, a cost resource may have a time phased contour where the cost resource is assigned over multiple time intervals defined for a task (e.g., days, weeks, months). The time phased contour may include fixed amounts of the cost resource or variable amounts of the cost resource, as desired for a given implementation. In this manner, a project management program may implement improved project accounting techniques and resources to assist a user in managing costs for a project. Other embodiments are described and claimed.

### BRIEF DESCRIPTION OF THE DRAWINGS

FIG. 1 illustrates one embodiment of a project management system.

FIG. 2 illustrates one embodiment of a first user interface screen.

FIG. 3 illustrates one embodiment of a second user interface screen.

FIG. 4 illustrates one embodiment of a third user interface screen.

FIG. 5 illustrates one embodiment of a fourth user interface screen.

FIG. 6 illustrates one embodiment of a first logic flow.

FIG. 7 illustrates one embodiment of a second logic flow.

FIG. 8 illustrates one embodiment of a computing system architecture.

### DETAILED DESCRIPTION

Various embodiments are generally directed to techniques to manage cost resources for a project. In one embodiment, for example, a project management program may be arranged to schedule cost resources for a project. The term project management program is used in a very broad sense to encompass any application program performing project management operations. Examples of such application programs suitable for managing various aspects of project management include but are not limited to scheduling software, resource allocation software, collaboration software, communication and documentation systems, all of which are collectively referred to herein as “project management software” or “project management program.” For example, a project management program may comprise any application program designed to assist project managers in developing plans, assigning resources to tasks, tracking progress, managing budgets, analyzing workloads, and other project management operations. A project is typically considered a temporary endeavor undertaken to create a unique product or service.

Conventional project management programs do not provide sufficient flexibility to assign arbitrary costs to tasks. In order to make it possible to assign, baseline and track multiple costs per task other than those driven by the assignments of work and material resources, various embodiments utilize a novel resource type referred to as a cost resource type. A cost resource is designed to cover all costs that do not depend on the amount of work for a task or duration for a task. Some examples of a cost resource may include but are not limited to those costs typically associated with travel, lodging, parking, car rental, tolls, meals, insurance premiums, accommodation, depreciation, security, basic utility fees, and any other fixed or non-variable costs. Once a cost resource has been defined, the cost resource may be assigned to a particular task for a project. In some cases, multiple cost resources may be assigned to the same task. Further, a cost resource may be apportioned over defined time intervals in a uniform or variable manner. As a result of a project management program implementing a robust and well-defined cost resource as a resource type, the project management program may provide more effective integration with financial and project accounting systems, and provide better cost estimation for projects.

A project management system may provide several advantages using a cost resource. For example, a project manager can assign any cost they want to a task as easily as assigning resources or materials in current project management programs. In another example, fixed costs can be added into the cost for a task. This can be accomplished by creating a list of cost resources before assignment, or that can define a cost resource during the actual assignment process. In yet another example, a project manager can spread the cost data for a task assignment over time thereby creating time phased data. In still another example, a project manager can readily see in a view which costs they have assigned to a particular task, and in some cases using the same view as used for costs from regular resource assignments (e.g., materials and labor). In yet another example, a project manager can log actual costs against the estimated costs whether fixed or time phased. The actual costs could be entered manually or imported from a financial system. In still another example, other cost assignments are saved to baselines. In yet another example, a project manager can receive reports indicating which costs they have assigned to a given task, and in some cases within the same report or report structure showing costs from regular resource assignments. In still another example, metadata may be defined for cost resources as with other resources, such as Cost Type and Accrue At, for example. In yet another example, cost resources may be standardized for enterprise project management. If cost resources are added to an enterprise resource pool, such as material resources, cost resources would not necessarily have or need a project server account, logon or user account. In a final example, cost resources could be assigned to a project summary task to support top-down budgeting techniques.

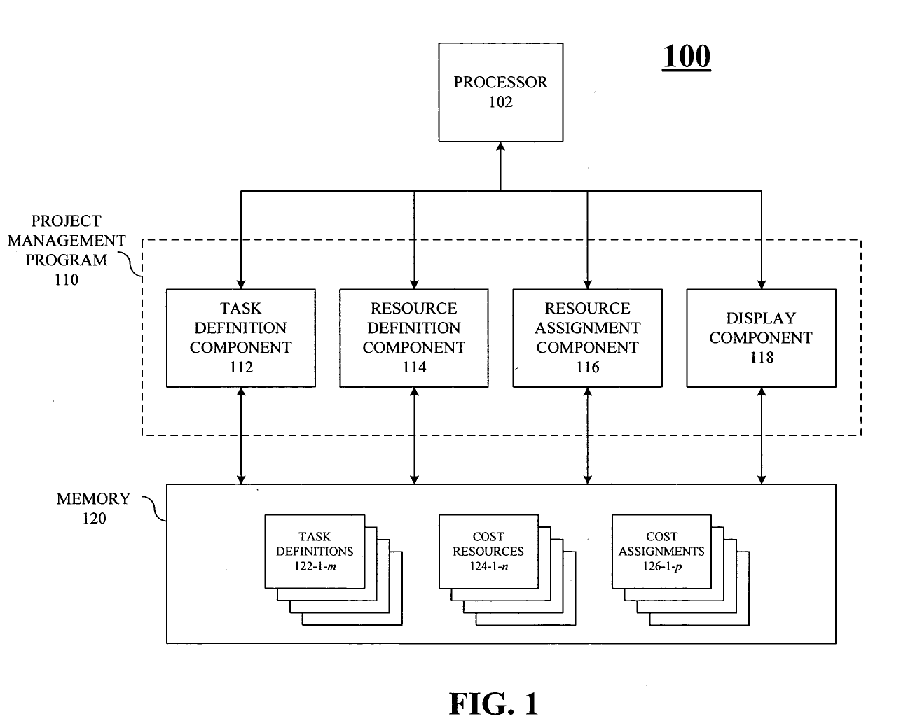

FIG. 1 illustrates a project management system 100. In various embodiments, the project management system 100 may be implemented as a computing device, system or platform for storing and executing project management software arranged to perform various project management operations. One example of a project management software suitable for implementing the cost resource techniques described herein may include an application program such as MICROSOFT® PROJECT made by MICROSOFT CORPORATION, Redmond, Wash. Although some embodiments may describe techniques for implementing cost resources in the context of MICROSOFT PROJECT application program by way of example, it may be appreciated that such techniques may also apply to other project management software and programs as well. The embodiments are not limited in this context.

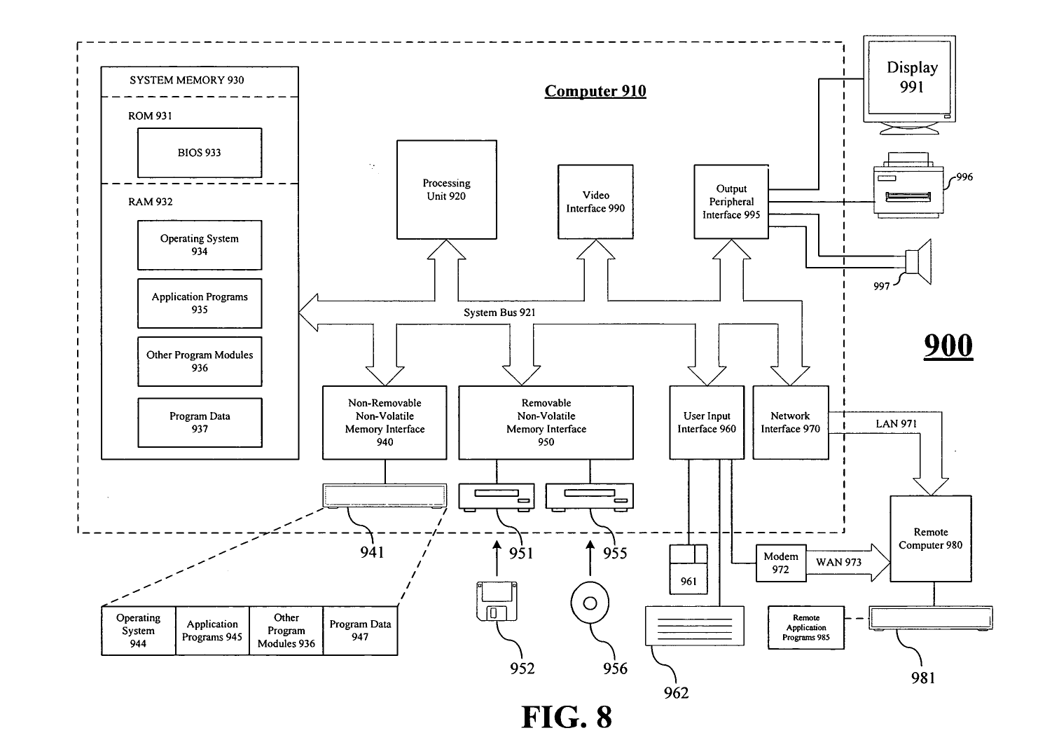

FIG. 1 shows a limited number of computing elements for the project management system 100, including a processor 102, a project management program 110, and a memory unit 120. The project management program 110 may include various software components, including a task definition component 112, a resource definition component 114, a resource assignment component 116, and a display component 118. It may be appreciated that these are merely some elements of a typical project management program, and the project management program 110 may include more or less elements arranged to perform various operations as desired for a given implementation. It may also be appreciated that FIG. 1 also illustrates a subset of elements typically implemented for a computing device or system, and a more detailed computing system architecture suitable for storing and executing the project management program 110 may be described with reference to FIG. 8.

As used herein the terms “component” and “system” are intended to refer to a computer-related entity, either hardware, a combination of hardware and software, software, or software in execution. For example, a component can be implemented as a process running on a processor, a processor, a hard disk drive, multiple storage drives (of optical and/or magnetic storage medium), an object, an executable, a thread of execution, a program, and/or a computer. By way of illustration, both an application running on a server and the server can be a component. One or more components can reside within a process and/or thread of execution, and a component can be localized on one computer and/or distributed between two or more computers as desired for a given implementation. The embodiments are not limited in this context.

In various embodiments, the project management program 110 may be arranged to schedule resources for a project. The project management program 110 may include various resource types, including a material resource type, a labor resource type, and so forth. In one embodiment, one of the resource types may comprise a cost resource type. The cost resource type may have multiple defined cost resources each representing a cost value independent of a volume of work for a task or duration for the task, as described in more detail below.

In one embodiment, for example, the task definition component 112 may be arranged to define one or more tasks 122-1-m for a project. In general, a task is typically part of a set of actions which accomplish a job, problem or assignment. In the context of project management, a task is typically an activity that needs to be accomplished within a defined period of time. Project tasks are often linked together to create dependencies. Examples of project tasks for a building project might include buying land, selecting a builder, designing a house, negotiating a price for the house, executing a contract, ordering building materials, and so forth. The number of tasks for a given project may have any level of granularity, and are typically defined by the project manager via the task definition component 112.

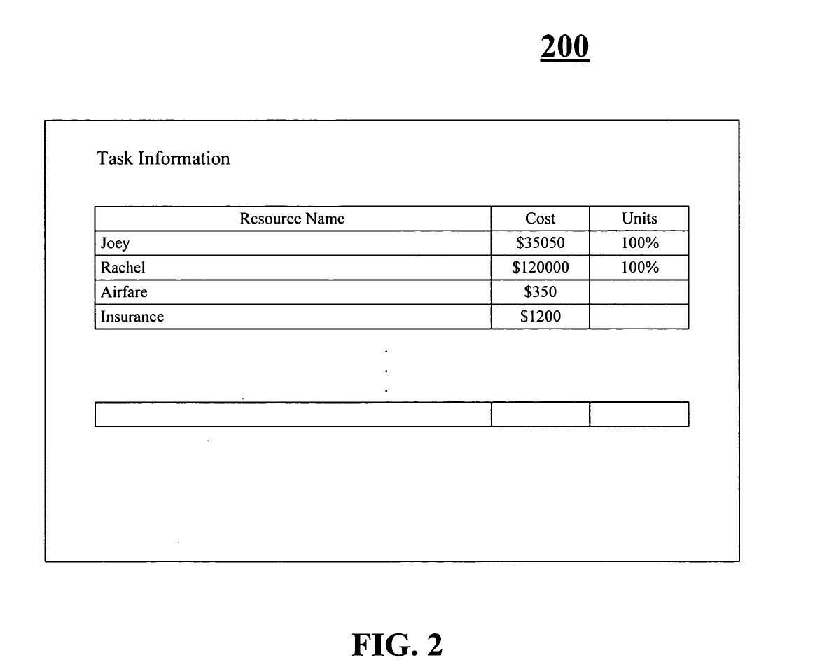

In one embodiment, for example, the resource definition component 114 may be arranged to define one or more cost resources 124-1-n for a project. A cost resource may cover all costs that do not depend on the amount of work for a task or the duration of a task. Many project management systems do not provide sufficient flexibility for a project manager to assign arbitrary costs to tasks. With the introduction of cost resources multiple non-resource related costs per tasks can be imported from financial systems or project accounting systems into projects, and project managers can estimate task costs more precisely. For example, assume a cost resource is defined for a travel cost. Typically travel costs do not vary as the volume or length of work increases. By way of contrast, a labor cost billed on an hourly basis may increase as more hours are worked for a task, and therefore would not be suitable for use as a cost resource. In some respects, a cost resource may be similar to those costs typically referred to as fixed costs, although in some cases the term fixed costs may be too rigid to encompass the full range of costs suitable for classification as a cost resource since by definition a fixed cost may never change. In addition to travel costs, some other examples of a cost resource may include but are not limited to those costs typically associated with lodging, parking, car rental, tolls, meals, insurance premiums, accommodation, depreciation, security, basic utility fees, and any other fixed or non-variable costs. An example of a graphic user interface (GUI) screen suitable for use with the resource definition component 114 may be shown in FIG. 2.

FIG. 2 illustrates a GUI screen 200. The GUI screen 200 is representative of a GUI screen used by MICROSOFT PROJECT for a Task Information dialog. As shown in FIG. 2, the GUI screen 200 may have multiple tabs, one of which is labeled a “Resource” tab. When the “Resource” tab is selected, a resource sheet appears with three columns titled “Resource Name,” “Cost,” and “Units.” The “Resource Name” column may have four defined resources, with the first two defined resources including individuals named “Joey” and “Rachel,” and the second two defined resources comprising cost resources named “Airfare” and “Insurance.” Further, a cost value of $350 has been entered into the “Cost” column for “Airfare,” and a cost value of $1200 has been entered into the “Cost” column for “Insurance.”

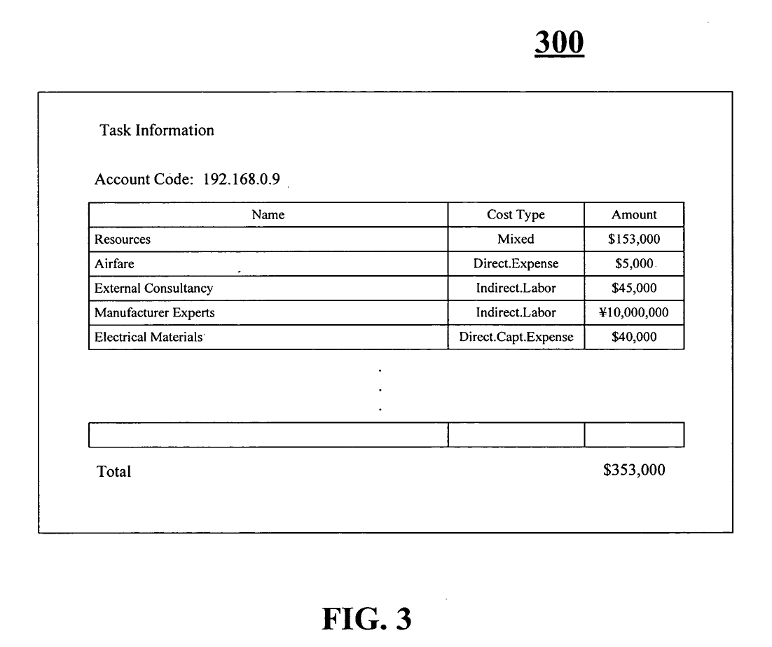

FIG. 3 illustrates a GUI screen 300. The GUI screen 300 is representative of an alternative GUI screen to the GUI screen 200 as used by MICROSOFT PROJECT for a Task Information dialog. The GUI screen 300 may be similar to the GUI screen 200 in some respects. Rather than having a cost resource defined and listed with other resources as in the GUI screen 200, however, the GUI screen 300 adds a separate tab named “Cost.” Further, the GUI screen 300 removes the “Unit” column and adds a “Cost Type” column. The “Cost Type” column may display the different cost types defined for a project, such as Mixed, Direct.Expense, IndirectLabor and Direct. CaptExpense. The GUI screen 300 may also add a total for the resources and a tally for the task cost.

Once the resource definition component 114 has been used to define one or more cost resources, the resource assignment component 116 may be used to assign one or more defined cost resources to a given task to create one or more cost assignments 126-1-p. In some cases, multiple cost resources may be assigned to a single task. For example, assume the task definition component 112 is used to define a task named “Proposal.” Further, assume the resource definition component 114 is used to define two cost resources, one for “Airfare” and one for “Lodging.” A project manager can assign costs for the multiple cost resources “Airfare” and “Lodging” to the single task “Proposal.” By way of contrast, many project management programs including MICROSOFT PROJECT have variable cost resource types such as Material and Labor that can be assigned to a single task, but typically allow only a single fixed cost resource to be assigned to a given task. The resource assignment component 116, however, may be arranged to allow multiple cost resources as defined herein to be assigned to a single task, thereby providing a much more robust cost management structure. An example of a GUI screen suitable for use with the resource assignment component 116 may be shown in FIG. 2.

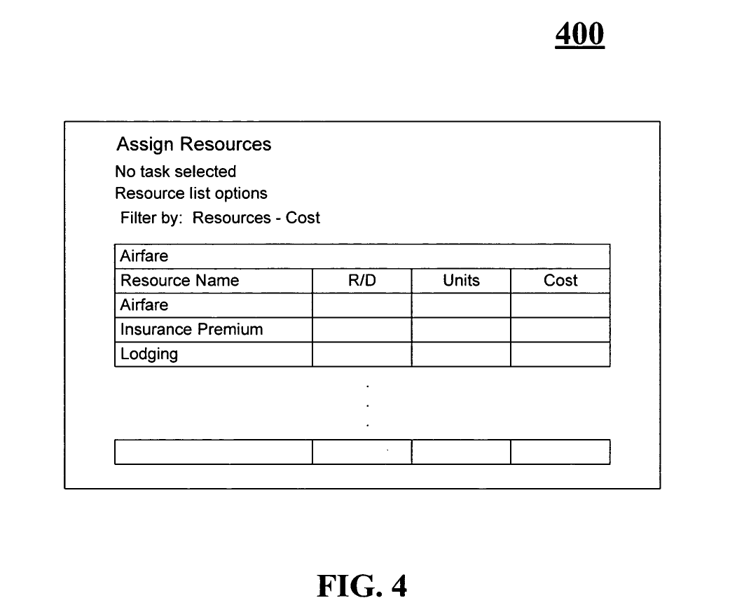

FIG. 4 illustrates a GUI screen 400. The GUI screen 400 is representative of a GUI screen used by MICROSOFT PROJECT for an Assign Resources dialog. As shown in FIG. 4, the GUI screen 400 includes a column titled “Resource Name” that includes three defined cost resources Airfare, Insurance Premium and Lodging. The GUI screen 400 also includes a column titled “Cost.” The GUI screen 400 allows a user to enter a cost value for each cost resource by entering a number in the “Cost” column. Once a cost value has been assigned to a cost resource, the cost resource may be assigned to a task. As shown in the GUI screen 400, multiple resources may be selected by holding down the CTRL button on an input device.

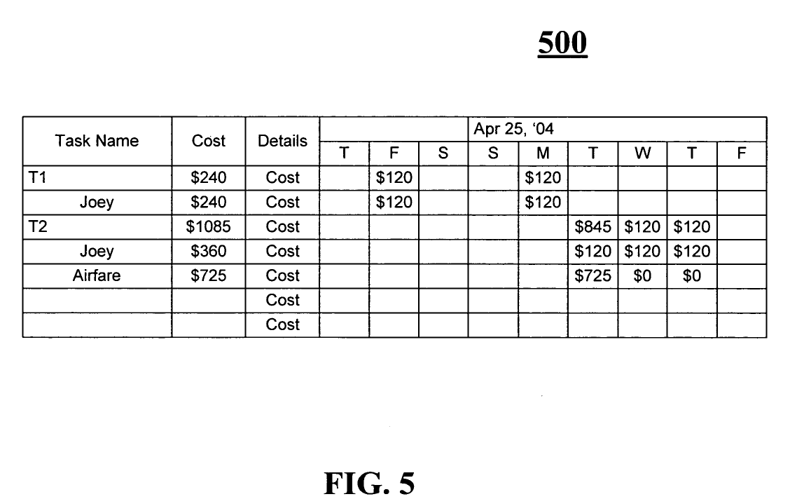

In one embodiment, for example, the resource assignment component 116 may be arranged to assign a cost resource to a task over multiple time intervals. The resource assignment component 116 allows a cost resource to be apportioned over defined time intervals in a uniform or variable manner, sometimes referred to as time phased contours. As a result, users will be able to spread a cost resource over time, either through manual time phased contours or evenly using a prorating technique such as the accrual method. In one embodiment, for example, the resource assignment component 116 may be arranged to assign a first portion of a cost resource to a task for a first time period, and a second portion of a cost resource to the task for a second time period. In one embodiment, for example, the first portion and the second portion may have identical values. In one embodiment, for example, the first portion and the second portion may have different values. An example of a GUI screen suitable for use with this aspect of the resource definition component 114 may be shown in FIG. 5.

FIG. 5 illustrates a GUI screen 500. The GUI screen 500 is representative of a GUI screen used by MICROSOFT PROJECT for a Task Usage View. As shown in the left hand side of FIG. 5, the GUI screen 500 may have a column titled “Task Name.” The “Task Name” column may display various tasks Ti and T2, with T1 having a single resource “Joey” assigned to it, and T2 having two resources “Joey” and “Airfare” assigned to it. Further, a column titled “Cost” may include cost values for each resource, one of which is the cost resource “Airfare” having a cost value of $725. As shown in the right hand side of FIG. 5, the GUI screen 500 may have various columns each representing a different day of the week for successive weeks. Referring to the row for the cost resource named “Airfare,” the cost value of $725 may be apportioned over different days in the week. For the week starting with Apr. 24, 2004, the GUI screen 500 may have $725 allocated to Tuesday, $0 to Wednesday and $0 to Thursday. Instead of a time phase contour of $725/$0/$0 representing a round trip ticket purchased on Tuesday, it can be appreciated that the cost value of $725 may be allocated differently, such as a time phase contour of $367.50/$0/$367.50 representing a first one way trip ticket purchased on Tuesday and a second one way trip purchased on Thursday.

In one embodiment, for example, the display component 118 may be used to display a GUI specifically designed for the project management system 100. For example, the display component 118 may be used to display the various GUI screens 200, 300, 400 and 500 as described with reference to respective FIGS. 2-5. The display component 118 may interact with an operating system (OS) for the project management system 100, or in some cases in lieu of the GUI provided by the resident OS.

Operations for the project management system 100 may be further described with reference to one or more logic flows. It may be appreciated that the representative logic flows do not necessarily have to be executed in the order presented, or in any particular order, unless otherwise indicated. Moreover, various activities described with respect to the logic flows can be executed in serial or parallel fashion. The logic flows may be implemented using one or more elements of the project management system 100 or alternative elements as desired for a given set of design and performance constraints.

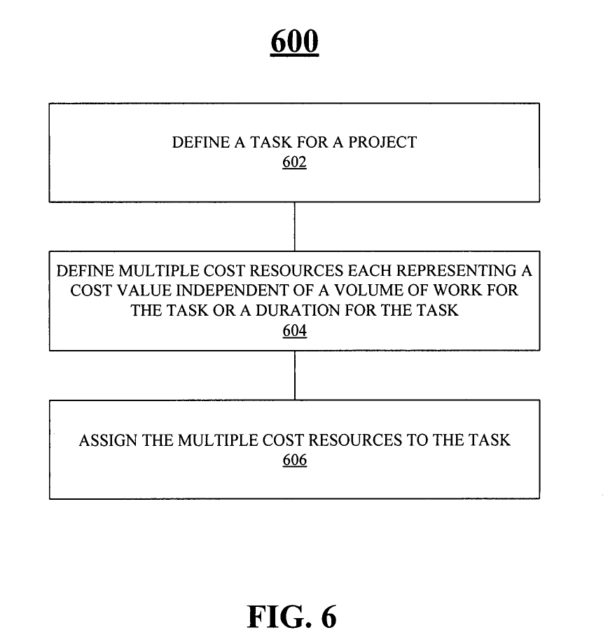

FIG. 6 illustrates a logic flow 600. The logic flow 600 may be representative of the operations executed by one or more embodiments described herein. As shown in FIG. 6, the logic flow 600 may define a task for a project at block 602. The logic flow 600 may define multiple cost resources each representing a cost value independent of a volume of work for the task or a duration for the task at block 604. The logic flow 600 may assign the multiple cost resources to the task at block 606. The embodiments are not limited in this context.

In one embodiment, the cost resource may be assigned to the task over multiple time intervals. For example, a first portion of a cost resource may be assigned to a first time interval, and a second portion of the cost resource may be assigned to a second time interval. In some cases, the first portion and the second portion may have equal values. In other cases, the first portion and the second portion may have unequal values.

In one embodiment, cost resource assignments may be monitored for budget purposes. For example, multiple cost resources may be defined with each cost resource representing an estimated cost value. An actual cost value may be received for the estimated cost value. In some cases, the actual cost value may be for a specific time period. The actual and estimated cost values may be compared to determine whether the actual cost value is above or below the estimated cost value.

The various embodiments may be further described by way of an example of a use scenario for the project management program 110. In an example for creating tasks and resources, assume Joey needs to create a project plan with 20 tasks and a few resources, to include Monica, Chandler and himself. He creates the task list in a Gantt chart view, and then switches to a resource sheet view to enter Monica, Chandler and himself to the list of resources. He also creates two cost resources, one for “Airfare” and one for “Lodging.” For each defined cost resource he enters the names and sets the resource type to Cost. He leaves the default setting for Accrue At on Start.

To assign resources to tasks, Joey switches back to the Gantt chart view, and clicks on the assign resources icon on the standard toolbar. This brings up the assign resources dialog showing Monica, Chandler and Joey in the resource list. He assigns them to the tasks by selecting the tasks and then clicking on the right resource name and then the assign button.

For one of the tasks he needs to assign “Airfare” as a cost. So he clicks on the cost radio button in the Assign Resources dialog (400) and now the list shows “Airfare” and “Lodging.” Also, the list now shows a “Cost” column instead of the “Units” column that was shown before when the work radio button was active.

Joey selects the task, clicks on “Airfare,” types in a cost value of $1200, and then clicks on the assign button. For another task, Joey selects “Lodging,” types in a cost value of $900 and again clicks on the assign button.

Continuing with our example, assume Joey desires to change the time phased contour for the “Lodging” cost resource. Because Joey will only stay 1 night in the hotel and Monica and Chandler 2 nights, the total cost amount of $900 does not reflect how the money will be spent over time. To change the time phased contour, Joey switches to a Task Usage View (500) and brings up the cost detail for the time phased pane. It currently shows $900 because the $900 he entered was entered on the 1st day of the task according to the Accrue At setting. But because Joey will check out on the 2nd day and Monica and Chandler on the 3rd day, Joey changes the time phased contour to $0/$300/ $600. Joey also notices that the airfare is booked on the first day of the task he assigned it to, just like he wants it.

Assume that Joey desires to view the cost per resource grouped by resource type. Curious to see the cost for all the resources in the project grouped by the resource types Work and Cost, Joey switches to the resource usage view and inserts the cost detail in the time phased pane and removes the work details as he's not interested in that. He also right clicks on the upper left corner of the sheet to select the cost table. From the menu, he selects “Project/Group By/More Groups” and clicks on “New.” He calls the new group “Resource Type” and checks the “Group assignments, not resources” option. Then he selects “Type” from the dropdown in the first field name cell and “Name” for the second field name cell. He then selects “OK” and “Apply.”

Assume that Joey desires to view the cost per task and the roll up for the project. For this he switches to the Task Usage View (500) and inserts the cost detail in the time phased pane and removes the work details as he is not interested in that. He also right clicks on the upper left corner of the sheet to select the cost table, and shows the project summary task by checking “Tools/Options/View/Show project summary task.”

In various embodiments, existing project management software such as MICROSOFT PROJECT may implement a new resource type such as a cost resource type by managing the cost resource type similar to other resource types, with some modifications to the project engine. More particularly, after a cost resource is assigned to a task, the project engine may schedule the task according to the formula Duration=Work/Units. For any task, a user can determine which piece of the equation the project engine calculates by setting the task type. Three task types defined by the project engine include fixed units, fixed work, and fixed duration. The project engine typically uses fixed units by default. A fixed-unit task is a task in which the assigned units (or resources) are a fixed value and any changes to the amount of work or work duration do not affect the task units. The project engine calculates this as Duration×Units=Work. A fixed-work task is a task in which the amount of work is a fixed value and any changes to the task duration or number of assigned units (or resources) do not affect the task work. The project engine also calculates this as Duration×Units=Work. A fixed-duration task is a task in which the duration is a fixed value and any changes to the work or the assigned units (or resources) do not affect the task duration. The project engine also calculates this as Duration×Units=Work.

Each of the task types affects scheduling when one of the three elements are modified, as shown in Table 1:

TABLE 1

| | | If duration is | If work is |
|---|---|---|---|
| In a . . . | If units are revised: | revised: | revised: |
| Fixed-units | Recalculate Duration | Recalculate Work | Recalculate |
| task | | | Duration |
| Fixed-work | Recalculate Duration | Recalculate Units | Recalculate |
| task | | | Duration |
| Fixed-duration | Recalculate Work | Recalculate Work | Recalculate |
| task | | | Units |

Since assignments of cost resources do not typically have values for Work or Units, however, these will not be recalculated when users changes the task Duration. In some cases, the task Duration would never be recalculated since users cannot make any changes to cost resource assignment Work or Units.

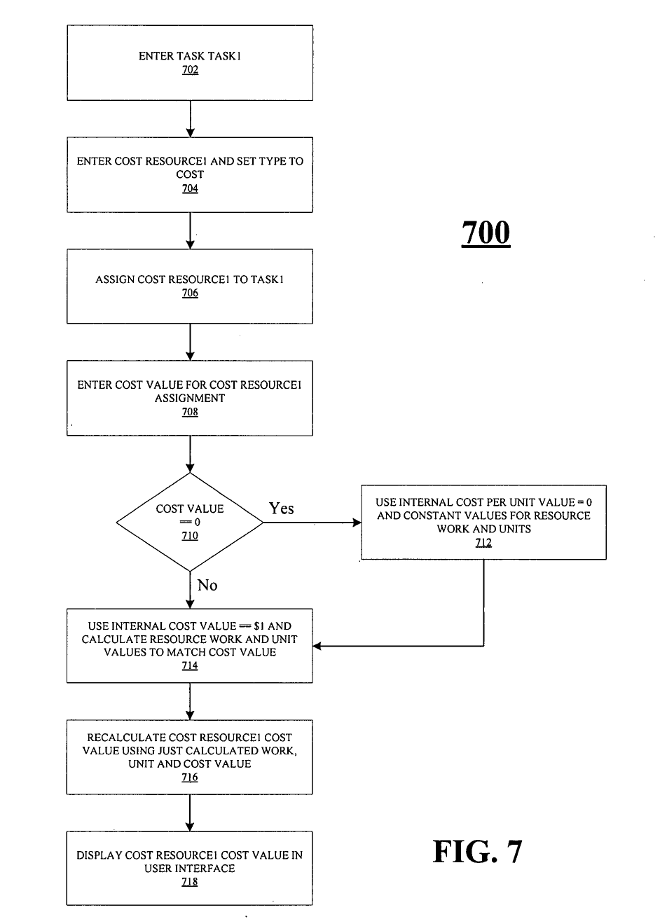

FIG. 7 illustrates a logic flow 700. The logic flow 700 may be representative of the operations executed by one or more embodiments described herein. The logic flow 700 may illustrate a specific example of implementing cost resources for MICROSOFT PROJECT. As shown in FIG. 7, the logic flow 700 may enter a task TASK1 at block 702. The logic flow 700 may enter a COST RESOURCE1 and set the resource type to Cost at block 704. The logic flow 700 may assign COST RESOURCE1 to TASK1 at block 706. The logic flow 700 may enter a COST VALUE for the COST RESOURCE1 assignment at block 708. A determination may be made as to whether the COST VALUE has been set to $0 at diamond 710. If the COST VALUE has not been set to $0 at diamond 710, then an INTERNAL COST VALUE is set to $1, and RESOURCE WORK and UNIT VALUES are calculated to match COST VALUE at block 714. The COST VALUE for the COST RESOURCE1 is recalculated using the just calculated WORK, UNIT and COST VALUE at block 716. The COST VALUE for the COST RESOURCE1 may be displayed by a GUI at block 718. If the COST VALUE has been set to $0 at diamond 710, then an INTERNAL COST PER UNIT VALUE is set to 0 and constant values are used for RESOURCE WORK and UNITS at block 712, and control is passed to block 714.

By way of example, as a user enters a cost value for a cost resource assigned to a task, the project engine converts the cost value to work so that when using a fixed internal cost per hour value for work unit a cost value may be calculated. Based on the entered cost value, the project engine calculates how many work units are needed to get the same cost value using an internal cost constant for work unit as it was entered by the user. The same rule applies to time phased cost values. Each entered time phased cost value is converted to a time phased work value for a selected time range, and a cost value is calculated using an internal cost per work unit constant. In some implementations, the project engine may be updated to ignore cost resource availability during task scheduling to prevent conflicts.

FIG. 8 illustrates a block diagram of a computing system architecture 900 suitable for implementing various embodiments, including the project management system 100. It may be appreciated that the computing system architecture 900 is only one example of a suitable computing environment and is not intended to suggest any limitation as to the scope of use or functionality of the embodiments. Neither should the computing system architecture 900 be interpreted as having any dependency or requirement relating to any one or combination of components illustrated in the exemplary computing system architecture 900.

Various embodiments may be described in the general context of computer-executable instructions, such as program modules, being executed by a computer. Generally, program modules include any software element arranged to perform particular operations or implement particular abstract data types. Some embodiments may also be practiced in distributed computing environments where operations are performed by one or more remote processing devices that are linked through a communications network. In a distributed computing environment, program modules may be located in both local and remote computer storage media including memory storage devices.

As shown in FIG. 8, the computing system architecture 900 includes a general purpose computing device such as a computer 910. The computer 910 may include various components typically found in a computer or processing system. Some illustrative components of computer 910 may include, but are not limited to, a processing unit 920 and a memory unit 930.

In one embodiment, for example, the computer 910 may include one or more processing units 920. A processing unit 920 may comprise any hardware element or software element arranged to process information or data. Some examples of the processing unit 920 may include, without limitation, a complex instruction set computer (CISC) microprocessor, a reduced instruction set computing (RISC) microprocessor, a very long instruction word (VLIW) microprocessor, a processor implementing a combination of instruction sets, or other processor device. In one embodiment, for example, the processing unit 920 may be implemented as a general purpose processor. Alternatively, the processing unit 920 may be implemented as a dedicated processor, such as a controller, microcontroller, embedded processor, a digital signal processor (DSP), a network processor, a media processor, an input/output (I/O) processor, a media access control (MAC) processor, a radio baseband processor, a field programmable gate array (FPGA), a programmable logic device (PLD), an application specific integrated circuit (ASIC), and so forth. The embodiments are not limited in this context.

In one embodiment, for example, the computer 910 may include one or more memory units 930 coupled to the processing unit 920. A memory unit 930 may be any hardware element arranged to store information or data. Some examples of memory units may include, without limitation, random-access memory (RAM), dynamic RAM (DRAM), Double-Data-Rate DRAM (DDRAM), synchronous DRAM (SDRAM), static RAM (SRAM), read-only memory (ROM), programmable ROM (PROM), erasable programmable ROM (EPROM), EEPROM, Compact Disk ROM (CD-ROM), Compact Disk Recordable (CD-R), Compact Disk Rewriteable (CD-RW), flash memory (e.g., NOR or NAND flash memory), content addressable memory (CAM), polymer memory (e.g., ferroelectric polymer memory), phase-change memory (e.g., ovonic memory), ferroelectric memory, silicon-oxide-nitride-oxide-silicon (SONOS) memory, disk (e.g., floppy disk, hard drive, optical disk, magnetic disk, magneto-optical disk), or card (e.g., magnetic card, optical card), tape, cassette, or any other medium which can be used to store the desired information and which can accessed by computer 910. The embodiments are not limited in this context.

In one embodiment, for example, the computer 910 may include a system bus 921 that couples various system components including the memory unit 930 to the processing unit 920. A system bus 921 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, Peripheral Component Interconnect (PCI) bus also known as Mezzanine bus, and so forth. The embodiments are not limited in this context.

In various embodiments, the computer 910 may include various types of storage media. Storage media may represent any storage media capable of storing data or information, such as volatile or non-volatile memory, removable or non-removable memory, erasable or non-erasable memory, writeable or re-writeable memory, and so forth. Storage media may include two general types, including computer readable media or communication media. Computer readable media may include storage media adapted for reading and writing to a computing system, such as the computing system architecture 900. Examples of computer readable media for computing system architecture 900 may include, but are not limited to, volatile and/or nonvolatile memory such as ROM 931 and RAM 932. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, radio-frequency (RF) spectrum, infrared and other wireless media. Combinations of the any of the above should also be included within the scope of computer readable media.

In various embodiments, the memory unit 930 includes computer storage media in the form of volatile and/or nonvolatile memory such as ROM 931 and RAM 932. A basic input/output system 933 (BIOS), containing the basic routines that help to transfer information between elements within computer 910, such as during start-up, is typically stored in ROM 931. RAM 932 typically contains data and/or program modules that are immediately accessible to and/or presently being operated on by processing unit 920. By way of example, and not limitation, FIG. 8 illustrates operating system 934, application programs 935, other program modules 936, and program data 937.

The computer 910 may also include other removable/non-removable, volatile/nonvolatile computer storage media. By way of example only, FIG. 8 illustrates a hard disk drive 940 that reads from or writes to non-removable, nonvolatile magnetic media, a magnetic disk drive 951 that reads from or writes to a removable, nonvolatile magnetic disk 952, and an optical disk drive 955 that reads from or writes to a removable, nonvolatile optical disk 956 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 941 is typically connected to the system bus 921 through a non-removable memory interface such as interface 940, and magnetic disk drive 951 and optical disk drive 955 are typically connected to the system bus 921 by a removable memory interface, such as interface 950.

The drives and their associated computer storage media discussed above and illustrated in FIG. 8, provide storage of computer readable instructions, data structures, program modules and other data for the computer 910. In FIG. 8, for example, hard disk drive 941 is illustrated as storing operating system 944, application programs 945, other program modules 946, and program data 947. Note that these components can either be the same as or different from operating system 934, application programs 935, other program modules 936, and program data 937. Operating system 944, application programs 945, other program modules 946, and program data 947 are given different numbers here to illustrate that, at a minimum, they are different copies. A user may enter commands and information into the computer 910 through input devices such as a keyboard 962 and pointing device 961, commonly referred to as a mouse, trackball or touch pad. Other input devices (not shown) may include a microphone, joystick, game pad, satellite dish, scanner, or the like. These and other input devices are often connected to the processing unit 920 through a user input interface 960 that is coupled to the system bus, but may be connected by other interface and bus structures, such as a parallel port, game port or a universal serial bus (USB). A monitor 991 or other type of display device is also connected to the system bus 921 via an interface, such as a video interface 990. In addition to the monitor 991, computers may also include other peripheral output devices such as speakers 997 and printer 996, which may be connected through an output peripheral interface 990.

The computer 910 may operate in a networked environment using logical connections to one or more remote computers, such as a remote computer 980. The remote computer 980 may be a personal computer (PC), a server, a router, a network PC, a peer device or other common network node, and typically includes many or all of the elements described above relative to the computer 910, although only a memory storage device 981 has been illustrated in FIG. 8 for clarity. The logical connections depicted in FIG. 8 include a local area network (LAN) 971 and a wide area network (WAN) 973, but may also include other networks. Such networking environments are commonplace in offices, enterprise-wide computer networks, intranets and the Internet.

When used in a LAN networking environment, the computer 910 is connected to the LAN 971 through a network interface or adapter 970. When used in a WAN networking environment, the computer 910 typically includes a modem 972 or other technique suitable for establishing communications over the WAN 973, such as the Internet. The modem 972, which may be internal or external, may be connected to the system bus 921 via the user input interface 960, or other appropriate mechanism. In a networked environment, program modules depicted relative to the computer 910, or portions thereof, may be stored in the remote memory storage device. By way of example, and not limitation, FIG. 8 illustrates remote application programs 985 as residing on memory device 981. It will be appreciated that the network connections shown are exemplary and other techniques for establishing a communications link between the computers may be used. Further, the network connections may be implemented as wired or wireless connections. In the latter case, the computing system architecture 900 may be modified with various elements suitable for wireless communications, such as one or more antennas, transmitters, receivers, transceivers, radios, amplifiers, filters, communications interfaces, and other wireless elements. A wireless communication system communicates information or data over a wireless communication medium, such as one or more portions or bands of RF spectrum, for example. The embodiments are not limited in this context.

Some or all of the project management system 100 and/or computing system architecture 900 may be implemented as a part, component or sub-system of an electronic device. Examples of electronic devices may include, without limitation, a processing system, computer, server, work station, appliance, terminal, personal computer, laptop, ultra-laptop, handheld computer, minicomputer, mainframe computer, distributed computing system, multiprocessor systems, processor-based systems, consumer electronics, programmable consumer electronics, personal digital assistant, television, digital television, set top box, telephone, mobile telephone, cellular telephone, handset, wireless access point, base station, subscriber station, mobile subscriber center, radio network controller, router, hub, gateway, bridge, switch, machine, or combination thereof. The embodiments are not limited in this context.

In some cases, various embodiments may be implemented as an article of manufacture. The article of manufacture may include a storage medium arranged to store logic and/or data for performing various operations of one or more embodiments. Examples of storage media may include, without limitation, those examples as previously provided for the memory unit 130. In various embodiments, for example, the article of manufacture may comprise a magnetic disk, optical disk, flash memory or firmware containing computer program instructions suitable for execution by a general purpose processor or application specific processor. The embodiments, however, are not limited in this context.

Various embodiments may be implemented using hardware elements, software elements, or a combination of both. Examples of hardware elements may include any of the examples as previously provided for a logic device, and further including microprocessors, circuits, circuit elements (e.g., transistors, resistors, capacitors, inductors, and so forth), integrated circuits, logic gates, registers, semiconductor device, chips, microchips, chip sets, and so forth. Examples of software elements may include software components, programs, applications, computer programs, application programs, system programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. Determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints, as desired for a given implementation.

Some embodiments may be described using the expression “coupled” and “connected” along with their derivatives. These terms are not necessarily intended as synonyms for each other. For example, some embodiments may be described using the terms “connected” and/or “coupled” to indicate that two or more elements are in direct physical or electrical contact with each other. The term “coupled,” however, may also mean that two or more elements are not in direct contact with each other, but yet still co-operate or interact with each other.

It is emphasized that the Abstract of the Disclosure is provided to comply with 37 C.F.R. Section 1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment. In the appended claims, the terms “including” and “in which” are used as the plain-English equivalents of the respective terms “comprising” and “wherein,” respectively. Moreover, the terms “first,” “second,” “third,” and so forth, are used merely as labels, and are not intended to impose numerical requirements on their objects.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

1. A method, comprising:
defining a task for a project;
defining multiple cost resources each representing a cost value independent of a volume of work for said task or a duration for said task; and
assigning said multiple cost resources to said task.

2. The method of claim 1, comprising assigning said cost resource to said task over multiple time intervals.

3. The method of claim 1, comprising assigning a first portion of a cost resource to a first time interval and a second portion of said cost resource to a second time interval.

4. The method of claim 1, comprising assigning a first portion of a cost resource to a first time interval and a second portion of said cost resource to a second time interval, said first portion and said second portion having equal values.

5. The method of claim 1, comprising assigning a first portion of a cost resource to a first time interval and a second portion of said cost resource to a second time interval, said first portion and said second portion having unequal values.

6. The method of claim 1, comprising displaying a view of said task and assigned cost resources.

7. The method of claim 1, comprising:
defining said multiple cost resources each representing an estimated cost value independent of a volume of work for said task or a duration for said task;
receiving an actual cost value for one or more estimated cost values; and
comparing said actual cost value with said estimated cost value.

8. An article comprising a storage medium containing instructions that if executed enable a system to:
define a task for a project;
define multiple cost resources each representing a cost value independent of a volume of activity or a duration of activity; and
assign said multiple cost resources to said task.

9. The article of claim 8, further comprising instructions that if executed enable the system to assign said cost resource to said task over multiple time intervals.

10. The article of claim 8, further comprising instructions that if executed enable the system to assign a first portion of a cost resource to a first time interval and a second portion of said cost resource to a second time interval.

11. The article of claim 8, further comprising instructions that if executed enable the system to assign a first portion of a cost resource to a first time interval and a second portion of said cost resource to a second time interval, said first portion and said second portion having equal values.

12. The article of claim 8, further comprising instructions that if executed enable the system to assign a first portion of a cost resource to a first time interval and a second portion of said cost resource to a second time interval, said first portion and said second portion having unequal values.

13. The article of claim 8, further comprising instructions that if executed enable the system to generating a report with said task and assigned cost resources.

14. An apparatus comprising a project management program arranged to schedule resources for a project, said project management program including multiple resource types with one of said resource types comprising a cost resource type, said cost resource type having multiple defined cost resources each representing a cost value independent of a volume of work for a task or a duration for said task.

15. The apparatus of claim 14, comprising a task definition component to define a task for said project.

16. The apparatus of claim 14, comprising a resource definition component to define said cost resources for said project.

17. The apparatus of claim 14, comprising a resource assignment component to assign multiple cost resources to a task.

18. The apparatus of claim 14, comprising a resource assignment component to assign said cost resource to said task over multiple time intervals.

19. The apparatus of claim 14, comprising a resource assignment component to assign a first portion of a cost resource to a task for a first time period, and a second portion of a cost resource to said task for a second time period, said first portion and said second portion having identical values.

20. The apparatus of claim 14, comprising a resource assignment component to assign a first portion of a cost resource to a task for a first time period, and a second portion of a cost resource to said task for a second time period, said first portion and said second portion having different values.
